(19) United States
(12) Patent Application Publication
(10) Pub. No.: US 2010/0108574 A1
(43) Pub. Date: May 6, 2010

(54) SIEVE DEVICE FOR CONTROLLED SIEVING

(75) Inventors: Boris Ouriev, Niederuzwil (CH); Oliver Schlien, Konstanz (DE); Manuel Hoehener, Uzwil (CH); Niklaus Schoenenberger, Herisau (CH); Roger Geissbuehler, Frauenfeld (CH)

Correspondence Address: BUCHANAN, INGERSOLL & ROONEY PC, POST OFFICE BOX 1404, ALEXANDRIA, VA, 22313-1404, US

(73) Assignee: BUEHLER AG, Uzwil (CH)

(21) Appl. No.: 12/278,535

(22) PCT Filed: Jan. 29, 2007
(86) PCT No.: PCT/CH2007/000039

§ 371 Date: Aug. 6, 2008

(30) Foreign Application Priority Data
Feb. 8, 2006 (DE) 10 2006 005 968.9

(51) Int. Cl. B07B 1/42; B07B 1/28

(52) U.S. Cl. 209/240; 209/365.1

(57) ABSTRACT

A screening device is disclosed for a pulverulent or granular material, such as a control screen for milled products including, but not limited to, flour, middlings or semolina. The device has an inlet for material to be screened, an outlet for rejections and an outlet for undersize Furthermore, the screening device can include a screen frame with a screen fastened thereto and a base framework. The screen frame can be mounted such that it can move relative to the base framework of the screening device and be coupled to a vibrating source by which the screen frame can be made to move with vibrating movements relative to the base framework of the screening device. During operation, the screen frame can be made to move with vibrating movements whose frequency is in the range from, for example, 15 Hz to 100 Hz and whose amplitude is in the range from, for example, 0.1 mm to 6 mm.

The invention relates to a sieve device for a pulverulent to granular sieving material, in particular to a control sieve for milling products, such as flour, middlings or semolina, comprising a sieving material inlet, a sieving reject outlet and a sifted material outlet, the sieve device comprising one or more sieve frames with a sieve attached to each as well as a base stand. The invention relates to a method for sieving a pulverulent to granular sieving material.

The invention relates to a method for sieving a pulverulent to granular sieving material.

Controlled sieving operations are necessary in many processes which produce bulk material and process or transport bulk material in order to prevent disruptive or dangerous foreign matter from entering delivered or packaged bulk material. This is particularly important in the processing and transportation of milling products, such as flour, middlings or semolina.

Since a controlled sieving operation usually takes place in a transport line in which the bulk material is transported by, for example, its gravity or by a pneumatic system, attempts are made on the one hand to keep the resistance, produced by the controlled sieving in the transport line, as low as possible, while on the other hand as fine a sieving operation as possible is desired in order to separate even small foreign matter from the bulk material.

The object of the invention is therefore to develop the sieve device mentioned at the outset in such a way that it allows a very fine sieving control in a flow of bulk material, simultaneously with low resistance to the bulk material flow.

This object is achieved with the sieve device mentioned at the outset in that the sieve frame is mounted movably relative to the base stand of the sieve device and is coupled with a vibration source by which the sieve frame may be set into vibratory movement relative to the base stand of the sieve device.

The vibratory movements of the sieve frame relative to the base stand of the sieve device cause a sieving action and prevent sieving material from building up on the sieve during operation, which can ultimately result in the sieve becoming blocked. Occupancy of the sieve may be substantially avoided and practically constant operating conditions are achieved in respect of the throughput of bulk material and—if a pneumatic transportation means is used—in respect of the drop in pressure in the pneumatic line. Moreover, the bulk material may be transported parallel to the sieve plane.

The sieve frame may preferably be set into vibratory movements, the frequency of which is in the range of from 15 Hz to 100 Hz and the amplitude of which is in the range of from 0.1 mm to 6 mm. In this frequency range, there are one or more natural sieve frequencies in the case of conventional sieves for fine bulk materials, such as flour, middlings, semolina etc., so that not only does the sieve frame/sieve unit (as a quasi rigid body unit) carry out a forced vibratory movement, but also the sieve performs membrane vibrations with relatively high amplitudes. In the process, the sieve is excited to a fundamental oscillation at the sieve basic frequency and to harmonics at sieve harmonic frequencies. Overall, this results in effective cleaning of control sieves.

In an advantageous embodiment, the sieve frame is mounted on the base stand so that it may be caused to vibrate by means of at least one oscillating spring arrangement, the sieve frame and the oscillating spring arrangement defining an oscillating unit of which the resonant frequency is substantially determined by the mass of the sieve frame and the spring constant of the oscillating spring arrangement.

In a sieve frame having a rectangular contour, a total of four oscillating spring arrangements of this type are preferably used which are positioned symmetrically and/or are evenly distributed round the contour of the sieve frame. It is advantageous if the oscillating spring arrangements are each positioned on the long sides of the rectangular sieve frame in the vicinity of the corners. Alternatively, the oscillating spring arrangements may also be positioned on each side of the rectangular sieve frame, in the middle of the side in each case. For sieve frames which have a different contour, for example a triangular, hexagonal or circular contour, the oscillating spring arrangements are likewise preferably positioned either in the corners or in the middle of the sides or are distributed evenly over the circumference of the circle.

It is beneficial if the frequency of the vibratory movements is in the range between 40 Hz and 80 Hz, operation preferably taking place in such a way that the sieve frame vibrations are close to the vibratory resonance of the sieve frame/spring unit. This means that a large amount of energy may be introduced into the bulk material by the sieve or sieves. It is particularly advantageous if the sieve frame operating vibrations are in the range of from 90 to 110% and preferably from 95% to 105% of the resonant frequency of the sieve frame/base stand vibrations.

It has been found specifically with flour that, at frequencies in the range of from 40 Hz to 80 Hz, the sieve effectively cleans itself during operation and the formation of agglomerated material and compression of the flour over the sieve is prevented.

In an advantageous embodiment, the operating vibration of the sieve device is 50 Hz or 60 Hz. This means that the alternating voltages of existing mains supplies may be used in a particularly simple manner as an energy source for powering the vibration sources.

The vibration source is expediently a source of mechanical oscillations or vibrations, it being possible for the vibration source to be coupled with the sieve frame by mechanical, inductive or capacitive means. The inductive and capacitive coupling methods are carried out without contact and are thus very low-wear and quiet.

The vibration source may also be a source of electromagnetic oscillations or vibrations, the vibration source being inductively or capacitively coupled with the sieve frame.

In a preferred embodiment, the sieve frame is mounted linearly on the base stand with one degree of freedom and coupled with the vibration source in such a way that the sieve frame may be set into a linear backwards and forwards motion. This embodiment is particularly simple, yet effective.

In a further preferred embodiment, the sieve frame is mounted in a planar manner on the base stand with two degrees of freedom and is coupled with the vibration source in such a way that the sieve frame may be set into a rotating, in particular an elliptical orbiting motion. This embodiment is extremely effective in preventing the sieve from becoming blocked over its entire surface.

In a particularly advantageous embodiment, the sieve frame is mounted movably relative to the base stand of the sieve device and is coupled with a first vibration source by which the sieve frame may be set into vibratory movements relative to the base stand of the sieve device, and the sieve device has an equalising element which is mounted movably relative to the base stand of the sieve device and is coupled with a second vibration source. As a result of both the sieve frame/sieve unit and the equalising element being respectively set into an oscillatory or vibratory motion, it is possible for the vibratory forces of the sieve device which act outwardly on, for example, bearings and foundations to be compensated. In this respect, the first vibration source and the second vibration source may preferably be powered in phase opposition to one another. The base stand is preferably used as the equalising element and is also sprung and cushioned with respect to the ground, the spring mounting between the sieve frame and the base stand having a low cushioning, while the spring mounting between the base stand and the ground have a high cushioning. Specific absorbing springs, for example, are used for this purpose.

The sieve frame and the equalising element may be mounted linearly on the base stand with one degree of freedom and may be coupled with the first vibration source or the second vibration source respectively in such a way that the sieve frame may be set into a linear backwards and forwards motion and the equalising element may be set into a backwards and forwards motion in phase opposition to the motion of the sieve frame, the vibration vectors of the first and second vibration sources preferably being collinear and the centres of gravity of the sieve frame/sieve unit and of the equalising element being located on the straight lines defined by the collinear vibration vectors. Consequently, cost-effective compensation of outwardly acting forces of the sieve device is achieved.

According to a further development, the sieve frame and the equalising element are mounted in planar manner on the base stand with two degrees of freedom and are coupled with the first vibration source or the second vibration source respectively in such a way that the sieve frame may be set into a rotating, in particular an elliptical path motion and the equalising element may be set into a rotating motion in phase opposition to the motion of the sieve frame, the two vibration vectors of the first and second vibration sources being coplanar and the centres of gravity of the sieve frame/sieve unit and of the equalising element being located in the plane defined by the coplanar vibration vectors. In this case also, compensation of outwardly acting forces of the sieve device is achieved, with the additional advantage that the sieve is equally free virtually everywhere from material remaining thereon.

The vibration vector preferably has a component which is perpendicular to the sieve plane of the sieve frame. This ensures fluidisation of the bulk material, as a result of which the flow resistance through the sieve is minimised.

If the vibration vector is oriented in such a way that it has one component perpendicular to, and one component parallel to the sieve plane of the sieve frame, transverse transportation of bulk material may be achieved, in addition to the fluidisation thereof.

It is particularly advantageous if the aforementioned equalising element is a second sieve frame which, like the first sieve frame, is mounted movably relative to the base stand of the sieve device and is coupled with the second vibration source.

Particularly effective compensation of outwardly acting vibration forces of the sieve device may be achieved in that the mass M1 and the vector components of the amplitude A1 of the vibration vector of the sieve frame/sieve unit on the one hand and the mass M2 and the vector components of the amplitude A2 of the vibration vector of the equalising element are selected in such a way that they are in a ratio of 0.5<(A1×M1)/(A2×M2)<1.5.

The following preferably applies to this ratio: 0.8<(A1×M1)/(A2×M2)<1.2.

The ratio (A1×M1)/(A2×M2) is generally selected in such a way that it is slightly smaller than one, since a certain amount of bulk material is always on the sieve during operation, so that during operation an effective mass M1* is produced which is slightly greater than M1. The ratio (A1×M1)/(A2×M2)=1 then approximately applies during operation, and effective compensation of the outwardly acting forces is achieved. The ground forces in particular may be minimised.

Expediently, 5<M2/M1<15 applies to the ratio of the mass M2 of the equalising element or of the base stand to the mass M1 of the sieve frame. The ratio 8<M2/M1<12 is preferred and M2/M1=10 applies in particular.

Since the power consumption P of the vibrating sieve frame and thus also of the bulk material over the sieve frame depends on the effective mass M of the sieve frame and on the amplitude A and the frequency f of the forced vibration (P is proportional to M, to A² and to f³ or P=k×M×A²×f³, wherein k is a constant), it is possible to achieve optimum operation for the respective bulk material and sieve by adjusting the amplitude A and the frequency f. This generally entails minimising the bulk material transport resistance through the sieve.

In a specific embodiment, the base stand is used as the equalising element. Alternatively, the multiple sieve frames of one sieve stack may also be mounted in such a way that they vibrate relative to one another. A sieve stack of this type preferably has two, four, six or a greater even number of identical or at least dimensionally identical sieve frames, where two of the sieves are always coupled in pairs and, within each pair, the two sieve frames are set into opposite phase vibratory motion. In this way, the sieve device according to the invention may be constructed in a compact manner and, during operation with sieve frame vibration, releases practically no dynamic forces to the surroundings and in particular does not release to the ground any great power peaks which add to the static ground load.

The aforementioned oscillating spring arrangements each have at least one helical spring. However, an oscillating spring arrangement consisting of two identical helical springs is advantageous, the first helical spring being fixed between an upper portion of the base stand and a portion of the sieve frame and the second helical spring being fixed between a lower portion of the base stand and a portion of the sieve frame. In this two-fold arrangement, the two helical springs are positioned collinearly with their longitudinal axes, in such a way that the mentioned portion of the sieve frame is mounted in the centre of a resulting helical spring which is double the length of each of the identical helical springs and is fixed between an upper portion and a lower portion of the base stand. A particularly advantageous helical spring arrangement is one which consists of four identical helical springs. This four-fold arrangement consists of two adjacent two-fold arrangements.

It is advantageous if the oscillating spring arrangements are mechanically pretensioned to a sufficient extent, i.e. if they are pre-compressed in the resting state. In this case, the butt joints between the ends of the oscillating spring arrangements and the portions of the base stand or the butt joints between the ends of the individual helical springs and the portions of the sieve frame are constantly subjected to pressure in vibration mode as well. This contributes to smooth running, since metal does not impact on metal in vibration mode.

It is particularly advantageous if, in the case of at least one helical spring, the straight connecting line runs through the first end of the helical spring winding and through the second end of the helical spring winding non-parallel to the longitudinal axis of the helical spring. Since the helical springs are alternately compressed and extended in vibration mode, the angles of inclination of the individual helical spring windings also constantly change. This also applies to the two outermost windings at both ends of a helical spring. Even when the two last windings periodically move away from the contact surface on the base stand or on the sieve frame and move towards said contact surface again, the two ends of the helical spring winding remain in constant contact with the sieve frame and the base stand. This results in a force component and movement component, caused by the alternatingly compressed and extended helical springs, of the sieve frame and base stand in a horizontal direction in addition to the (generally ever greater) force component and movement component of the sieve frame and base stand in a vertical direction.

Rotation of the at least one mounted helical spring about its longitudinal axis allows this non-parallelism between the straight connecting line of the ends of the helical spring winding and the helical spring longitudinal axis, and thus the magnitude of the horizontal components, to be adjusted. Due to this possibility of adjusting the vector of the force amplitude and the vector of the movement amplitude of the sieve frame, it is possible, for example, to adjust and optimise the throughput of flour through the sieve as well as the transport of flour parallel to the plane of the sieve.

It is expedient if, for each of the helical springs, the straight connecting line runs through the first end of the helical spring winding and through the second end of the helical spring winding, non-parallel to the helical spring longitudinal axis.

It is then possible, by rotating not only one or more selected helical springs about their longitudinal axes, but by rotating all the helical springs about their longitudinal axes, to adjust the force amplitude vector and the movement amplitude vector of the sieve frame. The angle between the direction of the straight connecting line and the direction of the helical spring longitudinal axis may be in the range of from 1° to 45° and preferably in the range of from 5° to 30°.

A particularly preferred embodiment of the sieve device according to the invention is characterised in that, for all the helical springs of the oscillating spring arrangement, the distance s₁, measured parallel to the helical spring longitudinal axis, between the mutually facing surfaces of the first spring end and of the winding adjacent to the first spring end as well as the distance s₂, measured parallel to the helical spring longitudinal axis, between the mutually facing surfaces of the second spring end and of the winding adjacent to the second spring end is greater than the amplitude of the extension vibration or the maximum extension of the spring dₘₐₓ divided by the number n of windings of the respective helical spring, i.e. s₁>dₘₐₓ/n and s₂>dₘₐₓ/n. This prevents these mutually facing adjacent surfaces of the helical springs from touching one another in vibration mode. This measure contributes significantly to the smooth running of a sieve device of this type.

The end of the helical springs resting on the sieve frame and the end resting on the base stand may be planar in each case, in such a way that a planar contact surface directed towards the sieve frame and a planar contact surface directed towards the base frame is respectively present. This provides a stable seat for the helical springs on the portions of the base stand and the sieve frame.

In this embodiment, the two planar contact surfaces may extend parallel to each other and non-orthogonally to the helical spring longitudinal axis.

Consequently, it is also possible in this case to adjust the force amplitude vector and the movement amplitude vector of the sieve frame by rotating one or more selected helical springs or all the helical springs about their longitudinal axes. The angle between the direction of the normal to the contact planes and the direction of the helical spring longitudinal axis may are in the range of from 1° to 30° and preferably in the range of from 5° to 15°.

In the method according to the invention, the pulverulent to granular material to be sieved is placed on to the sieve, while the sieve secured to a sieve frame is set, together with the sieve frame, into vibratory motion relative to a base stand. It has surprisingly been found that short sieve times are achieved in batchwise operation and high sieve yields in continuous operation, if the vibratory movements are carried out in such a way that the following applies to the amplitude a and to the frequency f of the vibratory movements of the sieve: 150 m²/s³<a²×ω³<500 m²/s³, where the angular frequency ω=2×π×f. The value a²×ω³=I is a measure of intensity.

The amplitude a is advantageously within the range of 1 mm<a<5 mm.

Particularly short sieve times or high sieve yields are obtained if 200 m²/s³<I<400 m²/s³. However, sieving is preferably carried out within the range of 250 m²/s³<I<350 m²/s³, the amplitudes preferably being within the range of 2 mm<a<4 mm.

Advantageous frequency ranges in this respect are 40 Hz<f<70 Hz, in particular 45 Hz<f<65 Hz.

Depending on the type of material to be sieved, short sieve times or high sieve yields are also obtained for the frequency ranges 40 Hz<f<48 Hz, 51 Hz<f<59 Hz, 62 Hz<f<70 Hz. The existing standard mains frequencies of 50 Hz (e.g. Europe) or 60 Hz (America) can advantageously also be used with relatively favourable electrical vibration drives.

Further advantages, features and possible applications of the invention will emerge from the following description of non-limiting examples given with reference to the drawings, in which:

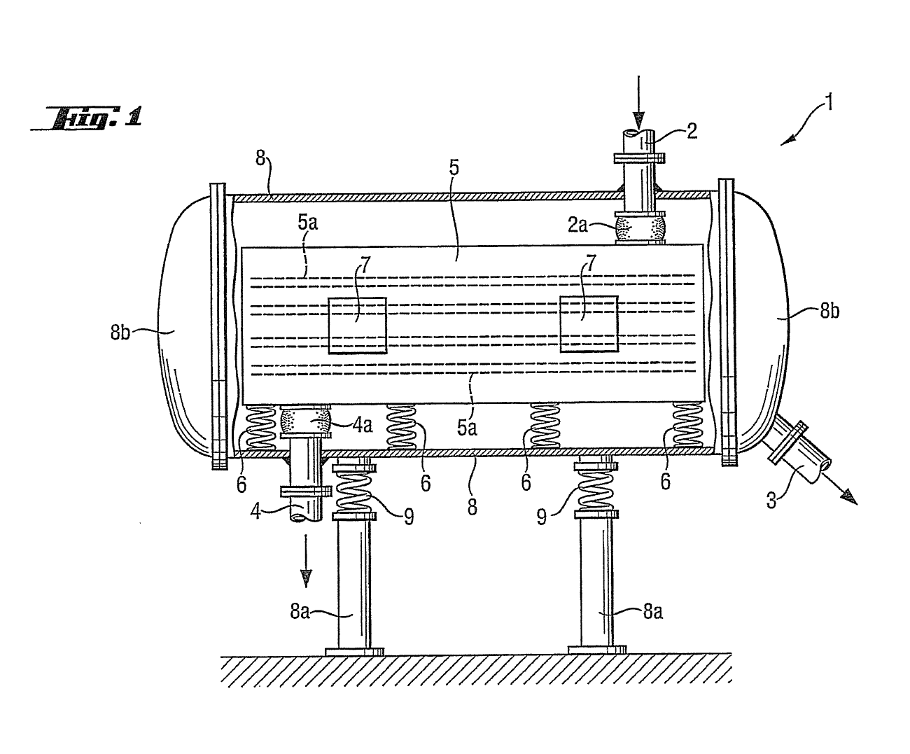

FIG. 1 is a schematic view of a sieve device according to the invention along a vertical sectional plane;

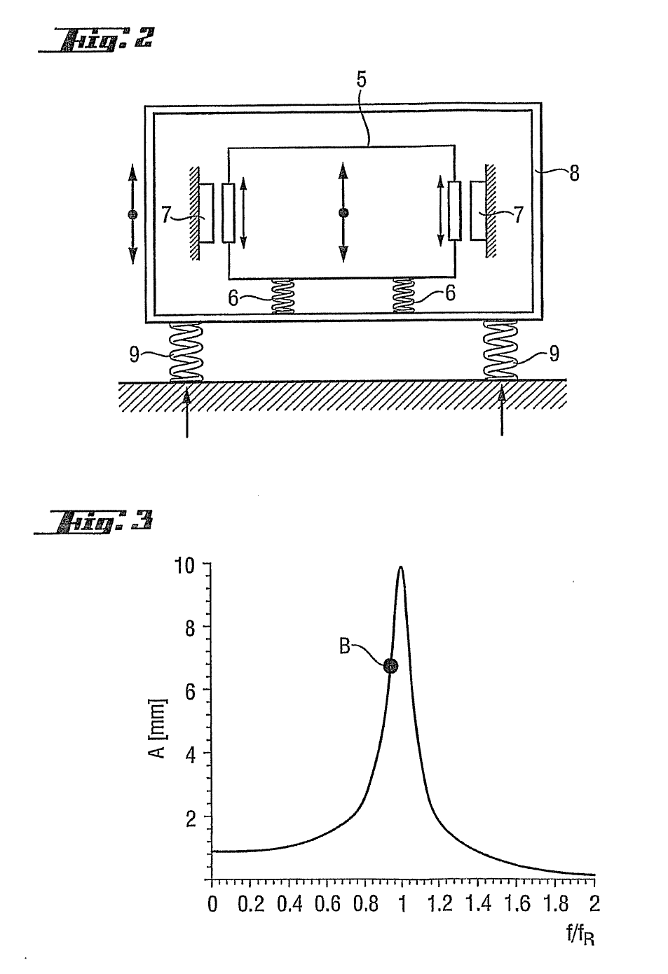

FIG. 2 schematically shows the portions, which may be set into vibratory motion, of the sieve device of FIG. 1 along the vertical sectional plane;

FIG. 3 shows the operating point in the amplitude response of the vibrating portions of the sieve device according to the invention;

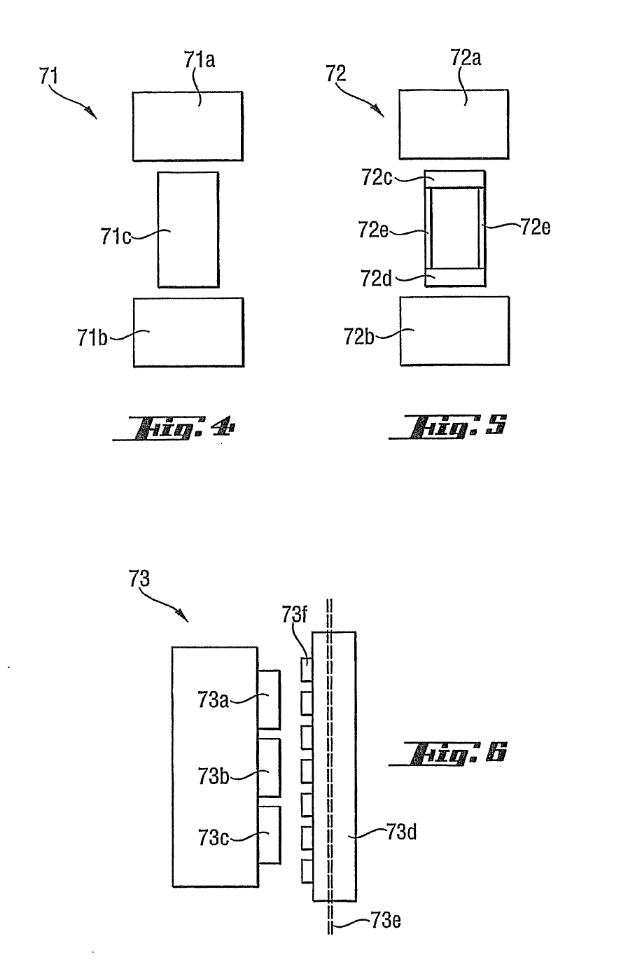

FIG. 4 schematically shows a first example of a linear drive according to the invention;

FIG. 5 schematically shows a second example of a linear drive according to the invention;

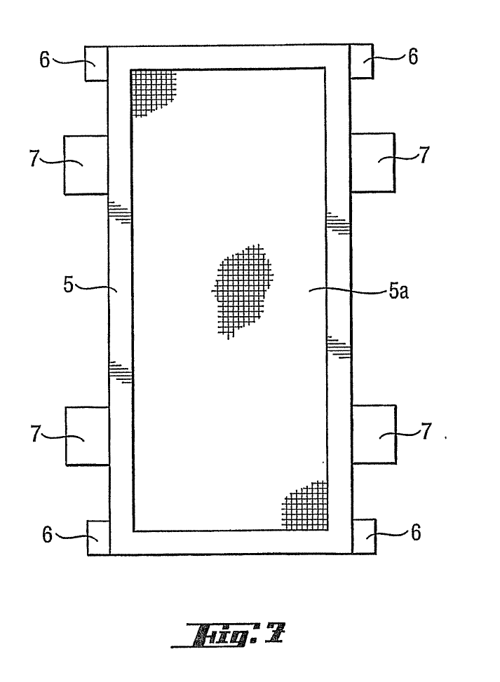

FIG. 6 schematically shows a third example of a linear drive according to the invention;

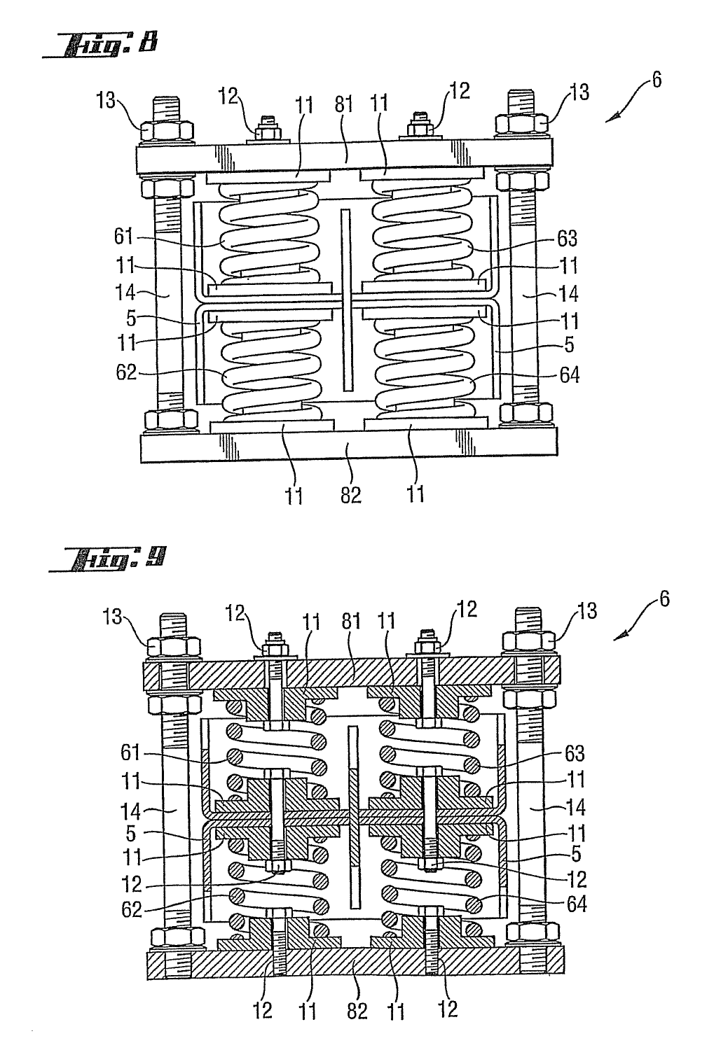

FIG. 7 is a schematic plan view of the sieve frame or sieve stack of the sieve device according to the invention;

FIG. 8 is a side view of an oscillating spring arrangement according to the invention;

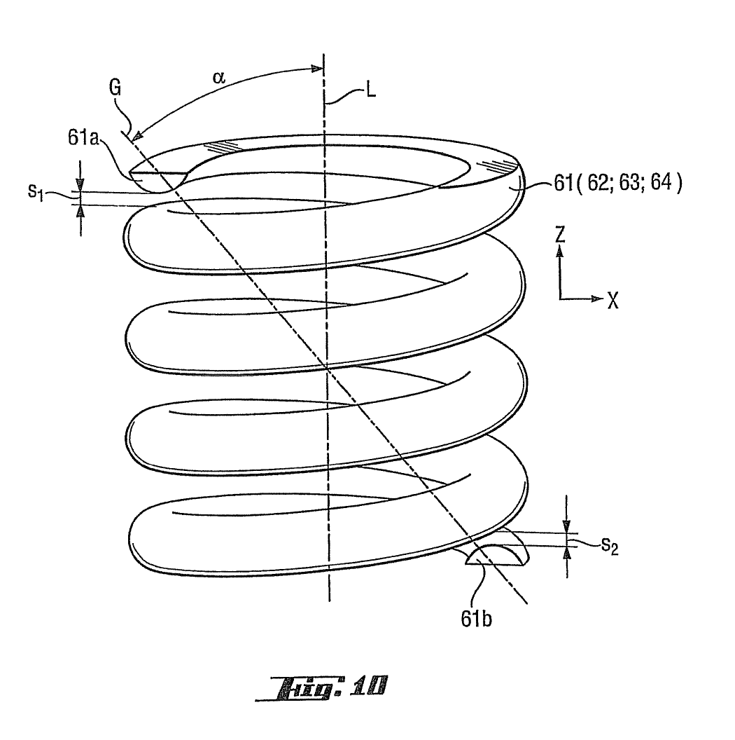

FIG. 9 is a partial sectional view of the oscillating spring arrangement of FIG. 8 along a vertical sectional plane; and

FIG. 10 is a side view of a helical spring used in the oscillating spring arrangement according to the invention.

FIG. 1 shows a sieve device 1 according to the invention which is used, for example, as a control sieve in a mill to remove foreign matter and other oversized particles from flour, middlings or semolina or from their packaging. The product to be subjected to controlled sieving passes via the sieving material inlet 2 into the sieve device 1 where it is guided onto a sieve 5a mounted in a sieve frame 5. Excessively large product particles, impurities or other foreign bodies are removed from the product flow via the sieving reject outlet 3. Acceptable product passes through the sieve 5a and leaves the sieve device 1 via the sifted material outlet 4.

The rigid sieve frame 5 with the sieve 5a mounted therein is positioned inside a base stand 8, is mounted in such a way that it may move relative to the base frame 8 and is coupled with four vibration sources 7 (only two of which are visible in FIG. 1) positioned on the edge of the frame. A plurality of oscillating springs 6 extend between the sieve frame 5 and the base stand 8 and enable the sieve frame 5, together with sieve 5a, to be set into vibratory movements relative to the base stand 8. Consequently, the product is fluidised over the sieve 5a. This minimises the resistance inevitably produced by the controlled sieving in the transport line, without in the process having to forego as fine a sieving action as possible in order to separate foreign matter from the bulk material.

The sieving material inlet 2 has a flexible inlet portion 2a which connects it to the sieve frame 5. Likewise, the sifted material outlet 4 has a flexible outlet portion 4a which connects it to the sieve frame 5. A similar flexible outlet portion (not shown) may also be provided on the sieving reject outlet 3.

Cushioning springs 9 are positioned between the base stand 8 and the stands or feet 8a as well as various casing parts 8b.

The chamber above the sieve (upper sieve chamber) and the chamber below the sieve (lower sieve chamber) have only one or a plurality of inlets 2 respectively or have only one or a plurality of outlets 4 respectively. FIG. 1 shows one inlet 2 and one outlet 4 respectively. The layer of flour, which is fluidised to a greater or lesser extent during operation, on the sieve 5a thus separates the upper sieve chamber and the lower sieve chamber from each other, i.e. a relatively small resistance develops for the air exchange between the upper and the lower sieve chambers (with strong fluidisation) or a relatively great resistance develops (with low fluidisation). The upwardly and downwardly vibrating sieve 5a leads to alternate compression and expansion of the air in the upper sieve chamber and, in phase opposition thereto, to expansion or compression of the air in the lower sieve chamber. This results in a suction-pump effect which has a positive influence on the sieve throughput. The suction-pump effect may be optimised if further openings are provided in the upper sieve chamber and/or in the lower sieve chamber, through which the upper and/or lower sieve chamber communicate/communicates with the surrounding atmosphere.

Instead of only one sieve frame 5 with the sieve 5a mounted therein, it is also possible for a plurality of sieve frames 5 of this type with a respective sieve to be positioned inside the sieve device 1 as an overall rigid sieve stack. It is also advantageous if two sieve frames 5 with a respective sieve 5a and overall the same mass are positioned either side by side or one above the other and are set into vibration in phase opposition to one another. Consequently, during a vibratory phase, the two sieve frames move either towards one another or away from each other with the same speed values. In this way, practically no reaction forces and inertial forces are transferred by the sieve frame 5 via the base stand 8. Thus, virtually no additional dynamic ground forces are exerted via the stands 8a, apart from the static ground forces.

The sieve frame 5 and the base stand 8 are preferably produced in a sandwich construction or from a composite material. It is particularly advantageous in this respect if the material of the sieve frame 5 and/or of the base stand 8 is honeycomb-like or porous, at least in certain regions, and in particular is made of a foamed material. The materials used for this purpose are preferably stainless steel, aluminium or a polymer, it being possible for the foamed regions to consist, for example, of aluminium or polymer. A sieve frame 5 and a base stand 8 constructed in this way each have a high rigidity, but a low mass.

FIG. 2 schematically shows the “rigid bodies” and “resilient bodies” described in FIG. 1. The two rigid bodies are formed by the sieve frame or sieve stack 5 and the base stand 8, while the resilient bodies are formed by the springs 6, 9. The sieve stack 5 may be set into vibration by vibration sources 7. It is the springs 6 designated as oscillating springs between the sieve stack 5 and the base stand 8 which are mainly responsible for the vibratory movements of the sieve stack 5 relative to the base stand 8. The springs 9 designated as bearing springs serve to suppress dynamic ground stresses which may possibly occur. For the oscillating springs 6, it is possible to use helical springs or leaf springs made of steel which have the minimum energy loss through inner friction during deformation thereof. For the bearing springs, apart from using steel springs, it is in particular possible to use springs made of elastomeric material or a steel/elastomer combination, which springs have the maximum energy loss through inner friction during deformation thereof, i.e. they have as great a cushioning effect as possible.

FIG. 3 shows the operating point B in the amplitude response of the forced oscillation/vibration of the sieve frame or the sieve stack 5 (see FIGS. 1 and 2). The amplitude is plotted in mm along the ordinate, while the ratio of the vibration frequency to the resonant frequency f/f_{R} is plotted along the abscissa. An excitation frequency f, to which 0.95<f/f_{R}<1.05 applies, is used for the forced vibration of the sieve frame or of the sieve stack 5. Consequently, sufficient energy may be introduced into the oscillation/vibration to achieve satisfactory fluidisation of flour, middlings or semolina so that the resistance of the control sieve is kept as low as possible.

FIG. 4 schematically shows a first example of a linear drive according to the invention which may be used as a vibration source (see FIGS. 1 and 2). The linear drive 71 is formed by a first electromagnet 71a and a second electromagnet 71b as well as by an iron armature 71c positioned between the two electromagnets 71a, 71b. The two electromagnets 71a, 71b are each rigidly fixed to the base stand 8 (see FIGS. 1 and 2), while the iron armature 71c is rigidly fixed to the sieve frame or sieve stack 5 (see FIGS. 1 and 2). The armature 71 is guided along a guide means (not shown). As a result of periodically connecting or disconnecting the electromagnets 71a, 71b or periodically reversing their polarity, the iron armature 71c is able to magnetise or reverse the magnetic poles respectively in such a way that it is possible to achieve a periodic backwards and forwards movement of the armature 71c due to the magnetic forces between the electromagnets and the armature. An oscillation/vibration may thus be forced on the sieve frame 5. The two electromagnets 71a, 71b may be powered, for example, by an alternating voltage power supply. The resulting alternating magnetic field thus attracts the armature 71c and produces its to and fro movement.

Soft iron is preferably used as the armature material.

Instead of a soft iron armature, it is also possible to use a permanently magnetised armature 71c consisting of a ferromagnetic alloy. The two electromagnets 71a, 71b are then periodically reversed in polarity. They are activated with the same frequency, but in phase opposition, in order to alternately produce a half period with upwardly acting force on the armature and a half period with downwardly acting force on the armature.

If a relatively small force input suffices in the sieve frame vibration, then instead of using two identical electromagnets, it is also possible to use only one of these electromagnets.

FIG. 5 schematically shows a second example of a drive according to the invention which may be used as a vibration source 7. The construction, the arrangement on the sieve frame 5 and on the base stand 8 and the operating mode are the same as for the first example of FIG. 4. In this case also, the linear drive 72 is formed by a first electromagnet 72a and a second electromagnet 72b and by an armature 72c, 72d, 72e positioned between the two electromagnets 72a, 72b. In this case, however, the armature consists of a first iron armature portion 72c facing the first electromagnet 72a and a second iron armature portion 72d facing the second electromagnet 72b, the two iron armature portions 72c, 72d being rigidly interconnected by an aluminium armature clip 72e.

Soft iron or a permanently magnetised ferromagnetic material may also be used in this case as the material for the armature portions. Instead of using aluminium for the armature clip, it is also possible to use a different non-ferromagnetic material.

FIG. 6 schematically shows a third example of a linear drive according to the invention. The arrangement on the sieve frame 5 and on the base stand 8 is the same as for the first and second examples of FIG. 4 and FIG. 5 respectively. In this case also, the linear drive 73 is formed by electromagnets 73a, 73b, 73c, positioned side by side as a kind of “battery”, as well as by an armature 73d which is equipped with a large number of permanent magnets 73f and is positioned beside the electromagnetic group 73a, 73b, 73c. The armature is guided along an armature guide 73e which is shown in dashed lines. The three electromagnets 73a, 73b, 73c may be powered, for example, by a three-phase power supply. The resulting travelling magnetic field thus attracts the armature 73d and produces its to and fro movement.

Instead of the single electromagnetic group 73a, 73b, 73c shown on the left-hand side of the armature 73d, it is also possible for a second electromagnetic group (not shown) to be positioned on the right-hand side of the armature 73d.

The linear drive of the third example has the advantage that the armature excursion may be considerably greater than in the case of the linear drives of the first and second examples.

The linear drives 71, 72 and 73 shown in FIG. 4, FIG. 5 and FIG. 6 respectively may be powered in a particularly simple manner by existing alternating current or three-phase current electric mains. In this embodiment, the voltage frequencies of 50 Hz or 60 Hz predetermined in electric mains of this type may advantageously be used to move the sieve frame or sieve stack 5 backwards and forwards relative to the base stand 8 at these frequencies.

FIG. 7 is a schematic plan view of the sieve frame or sieve stack 5 with the fixed sieve 5a of the sieve device 1 according to the invention. A total of four vibration sources 7 and a total of four oscillating springs 6 are positioned on the rectangular frame 5 in such a way that as few modal vibrations as possible of the frame 5 are excited at the vibration frequencies required for fluidisation of the bulk material. For a steel sieve frame 5 with an effective mass M1* (see page 5) of approximately 30-100 kg and a frame vibration frequency of 40-80 Hz suitable for the fluidisation of flour, middlings or semolina, it is possible to achieve a vibratory movement which is substantially free of modal vibrations of the frame 5, i.e. a pure upwards and downwards movement of the frame, if the four oscillating springs 6 are positioned at the corner points of the frame 5 or in the range of approximately 0-5% and 95-100% of the frame length and if the vibration sources 7 (“force input points”) are positioned in the range of approximately 20-40% and 60-80% of the frame length.

Similar considerations with respect to the arrangement of the oscillating springs 6 and the vibration sources 7 apply to other frame contours (square, triangular, elliptic or circular). The oscillating springs 6 are spaced consistently and uniformly and are positioned in particular at the corners of the frame 5, while vibration sources 7 are positioned respectively in the intermediate regions of the frame. The result of this arrangement of the oscillating springs 6 and vibration sources 7 is that less than 10% of the vibration energy stored in the sieve device 1 according to the invention is stored in modal vibrations of the frame 5 and by far the greatest portion of more than 90% is stored in the pure vibration, i.e. up and down movement of the frame, so the frame 5 behaves practically as a rigid body which predominantly performs rigid body vibrations.

A particularly compact and advantageous arrangement is one in which the vibration sources 7 and the oscillating springs 6 are positioned or overlap at one point in the plan view of the sieve frame 5.

The sieve frame or sieve stack 5 with a fixed sieve 5a of the sieve device 1 according to the invention may also be divided by partitions (not shown) above the fixed sieve 5a. The advantage of this segmenting of the sieve surface is that for practically all operating conditions and in particular when deviating from desired operating conditions (for example inclination of the sieve, air flow parallel to the sieve), a substantially uniform distribution of the sieving material is ensured over the sieve 5a within the sieve frame.

FIG. 8 is a side view of an oscillating spring arrangement according to the invention 6. It corresponds to an element 6 shown schematically in FIG. 7. The sieve frame 5 is fixed at a first point by a first upper oscillating spring 61 and a first lower oscillating spring 62 and at a second point by a second upper oscillating spring 63 and a second lower oscillating spring 64 in such a way that it may vibrate with respect to the base stand 8 (see FIG. 1) between an upper attachment plate 81 and a lower attachment plate 82 of the base stand 8, the attachment plates 81, 82 being interconnected by vertical connecting rods 14. The ends of the oscillating springs 61, 62, 63 and 64 are secured in each case by a spring socle 11 against slipping laterally with respect to the sieve frame 5 or to the attachment plates 81, 82 of the base stand 8. For this purpose, these spring socles 11 are secured on the sieve frame 5 or on the attachment plates 81, 82 of the base stand 8.

FIG. 9 is a partial sectional view of the oscillating spring arrangement 6 of FIG. 8 along a vertical sectional plane. The four oscillating springs 61, 62, 63 and 64, the spring socles 11 associated with their respective lower and upper spring ends, and the sieve frame 5 and the attachment plates 81, 82 of the base stand 8 are each shown in a vertical section. The spring socles 11 are each screwed by a screw connection 12 to the sieve frame 5 or to the attachment plates 81, 82 of the base stand 8. The helical springs 61, 62, 63 and 64 are each precompressed in the rest position shown in FIGS. 8 and 9 (no vibration of the sieve frame 5). This precompression is great enough for the oscillating springs 61, 62, 63 and 64 to always be pressed against the contact surface on the respective spring socle 11, even in the operating condition (with vibration of the sieve frame 5). This contributes to stable, low-noise operation of the sieve device according to the invention. To adjust the precompression of the oscillating springs, it is possible to move the upper attachment plate 81 slightly upwards or downwards along the connecting rods 14 and to fix said upper attachment plate 81 to the lower attachment plate 82 with this spacing. For this purpose, an adjusting screw connection 13 is associated with each connecting rod 14, and using this adjusting screw connection 13 it is possible to fix the position of the upper attachment plate 81 to the connecting rods 14.

The sieve fame 5 is thus fixed in a vibrating manner on the base stand 8 via upper and lower oscillating springs and may be set into vibration by one or more vibration sources 7 acting at uniformly distributed points of the sieve frame 5 (see FIG. 7). The bearing points of the sieve frame 5 are thus each positioned between upper oscillating springs 61, 63 and lower oscillating springs 62, 64.

FIG. 10 is a side view of a helical spring used in the oscillating spring arrangement of the invention, i.e. one of the helical springs 61, 62, 63 or 64 in FIG. 8. In this helical spring, the straight connecting line G runs through the first end 61a of the helical spring winding and through the second end 61b of the helical spring winding non-parallel to the helical spring longitudinal axis L. At least the two ends 61a and 61b of the helical spring winding remain in constant contact with the sieve frame 5 (see FIG. 8) and with the base stand 8 (see FIG. 8) in vibration mode. This results in a force component and a movement component induced by the alternately compressed and extended helical springs, of the sieve frame and base stand in horizontal direction X, in addition to the force component and movement component of the sieve frame and base stand in vertical direction Z. By rotating a mounted helical spring 61 about its longitudinal axis L, it is possible to adjust this non-parallelism between the straight connecting line G of the helical spring winding ends 61a, 61b and of the helical spring longitudinal axis L and thus the magnitude of the horizontal component. This means that the throughput of flour through the sieve and the transport of flour parallel to the sieve plane may be adjusted and optimised. Preferably, for each of the helical springs 61, 62, 63 and 64, the straight connecting line G through the first end of the helical spring winding and through the second end of the helical spring winding is non-parallel to the helical spring longitudinal axis L. Consequently, by rotating not only one, but preferably all the helical springs about their longitudinal axis, it is possible to adjust the force amplitude vector and the movement amplitude vector of the sieve frame 5 in the same position. The angle α between the direction of the straight connecting line and the direction of the helical spring longitudinal axis is in the range of from 25° to 35°.

The four oscillating springs 61, 62, 63 and 64 may also have non-circular cross sections perpendicularly to the spring longitudinal axis, in such a way that, depending on the direction of the load perpendicularly to the spring longitudinal axis, they have a different flexural strength. Oval oscillating spring cross sections are particularly preferred. In principle, any polygonal cross sections, such as a triangle, quadrangle, pentagon, hexagon etc. are possible in this embodiment. If oscillating springs of this type having non-circular cross sections are used in the oscillating spring arrangement 6, it is possible, similarly to the case described in the previous paragraph, to adjust the force amplitude vector and the movement amplitude vector of the sieve frame 5 by rotating these helical springs about their longitudinal axis.

For all the helical springs 61, 62, 63 and 64 (see FIG. 8) of the oscillating spring arrangement 6, the distance s₁ measured parallel to the helical spring longitudinal axis L, between the mutually facing surfaces of the first spring end 61a and the winding adjacent to the first spring end as well as the distance s₂ measured parallel to the helical spring longitudinal axis, between the mutually facing surfaces of the second spring end 61b and the winding adjacent to the second spring end is greater than the amplitude of the extension vibration or the maximum extension of the springs dₘₐₓ divided by the number n of the windings of the respective helical spring, i.e. s₁>dₘₐₓ/n and s₂>dₘₐₓ/n. This prevents these mutually facing surfaces of the helical springs from contacting one another in vibration mode. This measure plays a significant part in the smooth running of a sieve device of this type.

### Reference Numerals

1 sieve device/control sieve
2 sieving material inlet
2a flexible inlet portion
3 sieving reject outlet
4 sifted material outlet
4a flexible outlet portion
5 sieve frame/sieve stack
5a sieve
6 oscillating spring/oscillating spring arrangement
7 vibration source
8 base stand
8a stands
8b casing part
9 bearing spring/absorbing spring
11 spring socle
12 screw connection
13 adjusting screw connection
14 connecting rod
61 helical spring
62 helical spring
63 helical spring
64 helical spring
61a helical spring end
61b helical spring end
71 linear drive/vibration source
71a first electromagnet
71b second electromagnet
71c iron armature
72 linear drive/vibration source
72a first electromagnet
72b second electromagnet
72c iron armature portion
72d iron armature portion
72e aluminium armature clip
73 linear drive/vibration source
73a first electromagnet
73b second electromagnet
73c third electromagnet
73d armature
73e armature guide
73f permanent magnet
81 attachment plate
82 attachment plate
A, a amplitude
ω angular frequency
I measure of intensity
SZ sieving time
f frequency
s₁ distance
s₂ distance
G straight connecting line
L helical spring longitudinal axis
B operating point
α angle

1. Screening device for a pulverulent or granular material comprising:
an inlet for material to be screened;
an outlet for rejections and an outlet for undersize;
a screen frame with a screen fastened thereto; and
a base framework, wherein the screen frame is mounted in such a way as to be able to move relative to the base framework of the screening device and is coupled to a vibrating source by means of which the screen frame can be made to move with vibrating movements relative to the base framework of the screening device.

2. Screening device according to claim 1, wherein the screening device is arranged in a pneumatic duct.

3. Screening device according to either claim 1, wherein the screen frame can be made to move with vibrating movements, of which the frequency is in a range from 15 Hz to 100 Hz and of which the amplitude is in a range from 0.1 mm to 6 mm.

4. Screening device according to claim 3, wherein the frequency range of the vibrating movements lies between 40 Hz and 80 Hz.

5. Screening device according to claim 1, wherein the screen frame is mounted on the base framework so as to be able to vibrate of at least one vibrating spring arrangement in such a way that a vibration unit is formed by the screen frame and the vibrating spring arrangement.

6. Screening device according to claim 5, wherein the screen frame operation vibrations are in a range of 90% to 110%, of a resonant frequency of the screen frame vibration.

7. Screening device according to claim 1, wherein the vibrating source is a source of mechanical oscillations or vibrations and the vibrating source is inductively coupled to the screen frame.

8. Screening device according to claim 1, wherein the vibrating source is a source of electromagnetic oscillations or vibrations and the vibrating source is inductively coupled to the screen frame.

9. Screening device according to claim 1, wherein the screen frame is mounted in such a way as to be able to move relative to the base framework of the screening device and is coupled to a first vibrating source by means of which the screen frame can be made to move with vibrating movements relative to the base framework of the screening device, and wherein the screening device has a compensation member which is mounted in such a way as to be able to move relative to the base framework of the screening device and is coupled to a second vibrating source.

10. Screening device according to claim 9, wherein the first vibrating source and the second vibrating source can be driven in antiphase with one another.

11. Screening device according to either claim 9, wherein a vibration vector has a component perpendicular to a screen plane of the screen frame.

12. Screening device according to claim 11, wherein the vibration vector has a component perpendicular to and a component parallel to the screen plane of the screen frame.

13. Screening device according to claim 9, wherein the compensation member is a second screen frame which is mounted in such a way as to be able to move relative to the base framework of the screening device and is coupled to the second vibrating source.

14. Screening device according to claim 9, wherein the base framework is used as a compensation member.

15. Screening device according to claim 13, wherein a mass M1 and vector components of amplitude A1 of a vibration vector of the screen frame on one hand, and a mass M2 and vector components of amplitude A2 of a vibration vector of the compensation member or the second screen frame on another hand, are in a relationship:
0.5<(A1×M1)/(A2×M2)<1.5.

16. Screening device according to claim 15, wherein the relationship is such that: 0.8<(A1×M1)/(A2×M2)<1.2.

17. Screening device according to claim 5, wherein the vibrating spring arrangement has at least one helical spring.

18. Screening device according to claim 5, wherein the vibrating spring arrangement is mechanically pre-tensioned.

19. Screening device according to either claim 17, wherein each vibrating spring arrangement has at least one upper helical spring and at least one lower helical spring the at least one upper helical spring being clamped between a portion of the screen frame and an upper part of the base framework, and the at least one lower helical spring being clamped between a portion of the screen frame and a lower portion of the base framework.

20. Screening device according to 19, claim 19, wherein in the at least one upper or lower helical spring a connecting line passes through a first end of a helical spring coil and through a second end of the helical spring coil non-parallel to a helical spring longitudinal axis.

21. Screening device according to claim 20, wherein in each helical spring, a connecting line passes through a first end of the helical spring coil and through a second end of the helical spring coil non-parallel to the helical spring longitudinal axis.

22. Screening device according to either claim 20, wherein an angle between a direction of the connecting line and a direction of the helical spring longitudinal axis is in the range from 1° to 45°.

23. Screening device according to claim 19, wherein ends of the helical springs abutting the screen frame and abutting the base framework are each constructed so as to be planar, in such a way that a planar contact surface facing the screen frame and a planar contact surface facing the base framework are available.

24. Method for screening a pulverulent or granular material comprising:
moving a screen frame with a screen attached thereto with vibrating movements relative to a base framework while material to be screened is placed onto the screen, wherein the vibrating movements take place at an amplitude a and a frequency f, a measure of intensity I=a²×ω³ and an angular frequency ω=2×π×f being such that: 150 m²/s³<I<500 m²/s³; the amplitude a of the vibrating movements being such that: 1 mm<a<5 mm; and
configuring the screen for vibration to cause a compression and expansion of air in an upper screen chamber and, in antiphase therewith, an expansion and compression of air in a lower screen chamber, leading to a suction-compression effect which has a positive effect on the screen throughput.

25. Method according to claim 24, comprising:
placing the material to be screened onto the vibrating screen in batches.

26. Method according to either claim 24, comprising:
placing the material to be screened onto the vibrating screen continuously.

27. Screening device according to claim 5, wherein the screen frame operation vibrations are in a range of 95% to 105% of a resonant frequency of the screen frame vibration.

28. Screening device according to claim 20, wherein an angle between a direction of the connecting line and a direction of the helical spring longitudinal axis is in the range from 5° to 30°.
